(19) United States
(12) Patent Application Publication
(10) Pub. No.: US 2008/0298223 A1
(43) Pub. Date: Dec. 4, 2008

(54) PACKET DETECTING CIRCUIT AND METHOD THEREOF

(75) Inventors: CHI-TUNG CHANG, TAIPEI (TW); CHUEN-HENG WANG, TAIPEI (TW); TZU-WEN SUNG, TAIPEI (TW); YU-LING CHEN, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: ALCOR MICRO, CORP., TAIPEI (TW)

(21) Appl. No.: 11/832,221

(22) Filed: Aug. 1, 2007

(30) Foreign Application Priority Data
May 28, 2007 (TW) 96118987

(51) Int. Cl. H04J 11/00

(52) U.S. Cl. 370/203

(57) ABSTRACT

A packet detecting circuit detects a packet inputting time via calculating a delay correlation function and an autocorrelation function. In order to prevent a DC offset from affecting the calculation of the delay correlation function and the autocorrelation function, when the packet detecting circuit calculates the delay correlation function and the autocorrelation function, the packet detecting circuit will calculate and remove the error of the delay correlation function and the autocorrelation function produced by a DC offset. Then the packet detecting circuit calculates a packet triggering value according to the delay correlation function and the autocorrelation function for detecting the packet inputting time more precisely.

### BACKGROUND OF THE INVENTION

1. Field of the Invention

The present invention relates to a packet detecting circuit and a method thereof, and more particularly to a packet detecting circuit and its method free of any affection caused by a DC offset.

2. Description of Related Art

When a general packet detecting circuit is used to detect a packet, the packet detecting circuit calculates a delay correlation function and an autocorrelation function. Next, the circuit divides the delay correlation function by the autocorrelation function to obtain a packet detecting value, and then compares the packet detecting value with a predetermined threshold value to obtain the packet entry time, so as to achieve the purpose of the packet detection.

However, the portion of the DC offset is also included in the calculation when a packet detecting circuit having a DC offset calculates a delay correlation function and an autocorrelation function, and thus causing an error. Therefore, the packet detecting circuit cannot detect a packet accurately. In a general packet detecting circuit, the delay correlation function is calculated by:

$${\sum }_{n = 0}^{N - 1} {S}_{n} \times {S}_{n + D}^{*} \qquad ( Formula 1 )$$

where, Sₙ is the value of a signal inputted to a packet detecting circuit, S_{n+D} is the value of a signal inputted to a packet detecting circuit after delaying D sampling points. However, if there is a DC offset, the delay correlation function is calculated by:

$${\sum }_{n = 0}^{N - 1} {R}_{n} \times {R}_{n + D}^{*} = {\sum }_{n = 0}^{N - 1} ( {S}_{n} + {P}_{n} ) \times {( {S}_{n + D} + {P}_{n + D} )}^{*} = {\sum }_{n = 0}^{N - 1} {S}_{n} \times {S}_{n + D}^{*} + ( {\sum }_{n = 0}^{N - 1} {S}_{n} {P}_{n + D}^{*} + {P}_{n} {S}_{n + D}^{*} ) + {\sum }_{n = 0}^{N - 1} {P}_{n} \times {P}_{n + D}^{*} \qquad ( Formula 2 )$$

where, Rₙ=Sₙ+Pₙ, R_{n+D}=S_{n+D}+P_{n+D}, and Pₙ and P_{n+D} are DC offset values. Within a time period, if the DC offset is a constant P₀, and the average of the signal is zero, the delay correlation function is calculated by:

$${\sum }_{n = 0}^{N - 1} {R}_{n} \times {R}_{n + D}^{*} = {\sum }_{n = 0}^{N - 1} {S}_{n} \times {S}_{n + D}^{*} + {\sum }_{n = 0}^{N - 1} {\vert {P}_{0} \vert}^{2} \qquad ( Formula 3 )$$

Then, Formulas 1 and 3 are compared. Due to the DC offset, it is easy to misjudge the delay correlation function since an extra value of

$${\sum }_{n = 0}^{N - 1} {\vert {P}_{0} \vert}^{2}$$

is generated.

On the other hand, a general packet detecting circuit calculates an autocorrelation function by:

$${\sum }_{n = 0}^{N - 1} {\vert {S}_{n + D} \vert}^{2} \qquad ( Formula 4 )$$

where, S_{n+D} is the value of a signal inputted in a packet detecting circuit after delaying D sampling points. If there is a DC offset, the autocorrelation function is calculated by:

$${\sum }_{n = 0}^{N - 1} {\vert {R}_{n + D} \vert}^{2} = {\sum }_{n = 0}^{N - 1} {\vert {S}_{n + D} + {P}_{n + D} \vert}^{2} = {\sum }_{n = 0}^{N - 1} {\vert {S}_{n + D} \vert}^{2} + ( {\sum }_{n = 0}^{N - 1} {S}_{n + D} {P}_{n + D}^{*} + {S}_{n + D}^{*} {P}_{n + D} ) + {\sum }_{n = 0}^{N - 1} {\vert {P}_{n + D} \vert}^{2} \qquad ( Formula 5 )$$

where, R_{n+D}=S_{n+D}+P_{n+D}, and P_{n+D} is a DC offset value. Within a time period, if the DC offset is a constant P₀, and the average of the signal is zero, the autocorrelation function is calculated by:

$${\sum }_{n = 0}^{N - 1} {\vert {R}_{n + D} \vert}^{2} = {\sum }_{n = 0}^{N - 1} {\vert {S}_{n + D} \vert}^{2} + {\sum }_{n = 0}^{N - 1} {\vert {P}_{0} \vert}^{2} \qquad ( Formula 6 )$$

Then, Formulas 4 and 6 are compared. Due to the DC offset, the autocorrelation function for the signal will have an extra error

$${\sum }_{n = 0}^{N - 1} {\vert {P}_{0} \vert}^{2} .$$

From the description above, the DC offset will cause an error in the calculation of the delay correlation function and the autocorrelation function. To overcome the foregoing technical problem, a method for first eliminating the DC offset of a conventional art is provided to improve the affection of the DC offset to the detection of a packet.

Referring to FIG. 1 showing a functional block diagram of a prior art packet detecting circuit, the packet detecting circuit 10 comprises a delay correlation function calculating circuit 101, an autocorrelation function calculating circuit 102, a packet detection triggering value calculating circuit 103, and a switching unit 104.

Before the packet detecting circuit 10 utilizes the delay correlation function calculating circuit 101 and the autocorrelation function calculating circuit 102 to calculate the delay correlation function, a DC offset eliminator 11 is used to eliminate the DC offset first. In general, the DC offset eliminator 11 is used to prevent the calculation of the delay correlation function calculating circuit 101 and the autocorrelation function calculating circuit 102 from including the DC offset that causes an error and detection inaccuracy of the packet detecting circuit 10. After the DC offset eliminator 11 eliminates the DC offset of the input signal and the calculation of the delay correlation function and the autocorrelation function, the packet detection triggering value calculating circuit 103 determines a packet detection triggering time according to the calculation result of the delay correlation function and the autocorrelation function, and controls the switching unit 104 to output the signal.

However, the packet detecting circuit 10 needs to eliminate the DC offset by the DC offset eliminator 11 for accurately detecting the packet entry time. If the DC offset eliminator 11 fails, the DC offset may not be eliminated. Thus the packet detecting circuit 10 cannot detect the packet entry time accurately.

Besides the foregoing packet detecting circuit 10, some packet detecting circuits eliminate the DC offset by using noises beforehand and start the packet detection. But the DC offset may vary with temperature or other circuits, such that after the packet detection starts, sometimes the DC offset may still exist, and causes a computational error of the delay correlation function and the autocorrelation function, so that the packet detecting circuit cannot detect a packet entry time accurately.

### SUMMARY OF THE INVENTION

In view of the foregoing shortcoming of the prior art, it is a primary objective of the present invention to provide a packet detecting circuit that is not affected by a DC offset, so that the invention can calculate accurate delay correlation function and autocorrelation function for a signal when existing a DC offset. After that, the packet detecting circuit can detect a packet quickly.

To achieve the foregoing objective, the present invention provides a packet detecting circuit, comprising a delay correlation function calculating circuit, an autocorrelation function calculating circuit, an autocorrelation function DC offset elimination circuit and a packet detection triggering calculating circuit. The delay correlation function calculating circuit receives an input signal and calculates a delay correlation function for the input signal. The delay correlation function calculating circuit comprises an average deduction circuit for deducting an average time period of the input signal. The packet detecting circuit uses an autocorrelation function calculating circuit to receive the input signal, and calculates an autocorrelation function for the input signal; and an autocorrelation function DC offset elimination circuit is used for calculating a DC offset value, and subtracting the DC offset value from the autocorrelation function for the input signal; and the packet detection triggering calculating circuit calculates a packet detection triggering value to detect a packet entry time according to the output values of the delay correlation function calculating circuit and the autocorrelation function DC offset elimination circuit.

The present invention further provides a packet detecting circuit, comprising a delay correlation function calculating circuit, a delay correlation function DC offset elimination circuit, an autocorrelation function calculating circuit, an autocorrelation function DC offset elimination circuit and a packet detection triggering calculating circuit. The packet detecting circuit uses a delay correlation function calculating circuit to calculate an input signal of the delay correlation function, and a delay correlation function DC offset elimination circuit to calculate a first DC offset value, and the first DC offset value is subtracted from the computational result of the delay correlation function calculating circuit. The autocorrelation function calculating circuit calculates the autocorrelation function for the input signal, and the autocorrelation function DC offset elimination circuit calculates a second DC offset value, and subtracts the second DC offset value from the computational result of the autocorrelation function calculating circuit. Finally, the packet detection triggering calculating circuit calculates a packet detection triggering value to detect a packet entry time according to the output values of the delay correlation function DC offset elimination circuit and the autocorrelation function DC offset elimination circuit.

The present invention further provides a packet detecting method, comprising the steps of: receiving a signal; calculating a delay correlation function for the signal, wherein the delay correlation function is produced by deducting an average time period of the signal for calculating an autocorrelation function and a DC offset value, and the autocorrelation function subtracts the DC offset value; and finally computes a packet detection triggering value to detect a packet entry time according to the delay correlation function and after the autocorrelation function subtracts the DC offset value.

The present invention provides a packet detecting method, comprising the steps of: receiving a signal; computing a delay correlation function and a first DC offset value, and subtracting the first DC offset value from the delay correlation function; calculating an autocorrelation function and a second DC offset value, and subtracting the second DC offset value from the autocorrelation function; finally calculating a packet detection triggering value to detect a packet entry time according to the delay correlation function minus the first DC offset value and the autocorrelation function minus the second DC offset value.

To make it easier for our examiner to understand the innovative features and technical content, we use preferred embodiments together with the attached drawings for the detailed description of the invention, but it should be pointed out that the attached drawings are provided for reference and description but not for limiting the present invention.

### BRIEF DESCRIPTION OF THE DRAWINGS

FIG. 1 is a functional block diagram of a prior art packet detecting circuit;

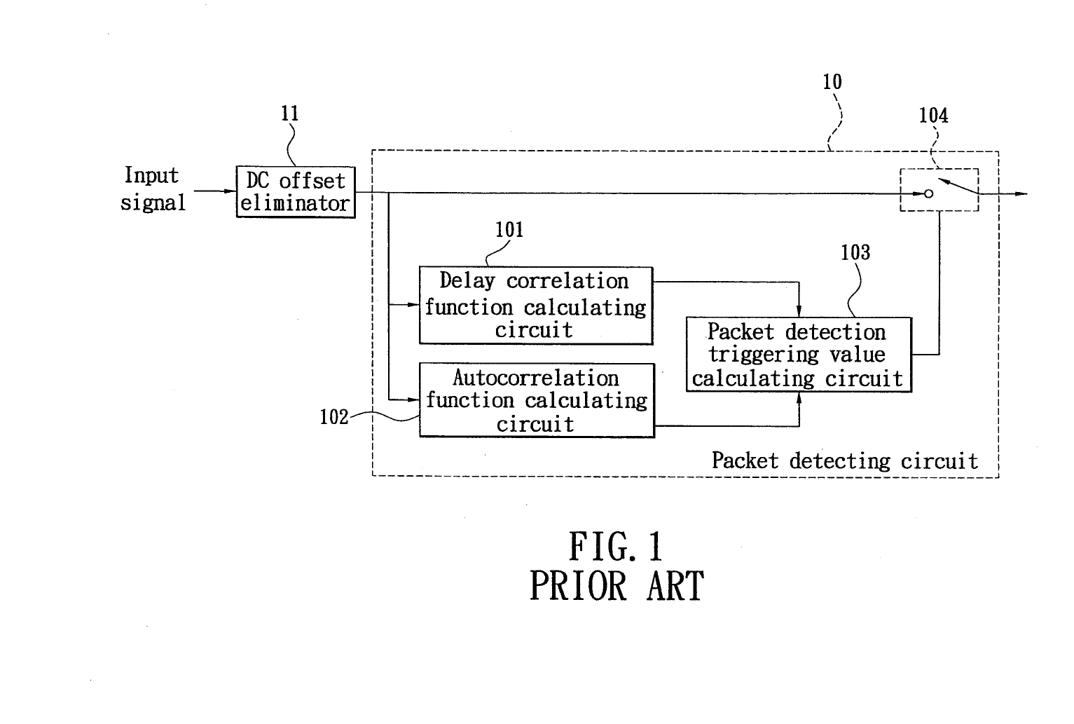

FIG. 2 a functional block diagram of a packet detecting circuit in accordance with a first preferred embodiment of the present invention; and

FIG. 3 a functional block diagram of a packet detecting circuit in accordance with a second preferred embodiment of the present invention

### DETAILED DESCRIPTION OF THE PREFERRED EMBODIMENTS

The present invention uses a concept of variables in statistics to eliminate the affection of DC signal to the packet detecting circuit, such that the packet circuit having a DC offset can precisely calculate the delay correlation function and the autocorrelation function for the signal, and quickly detect a packet entry time.

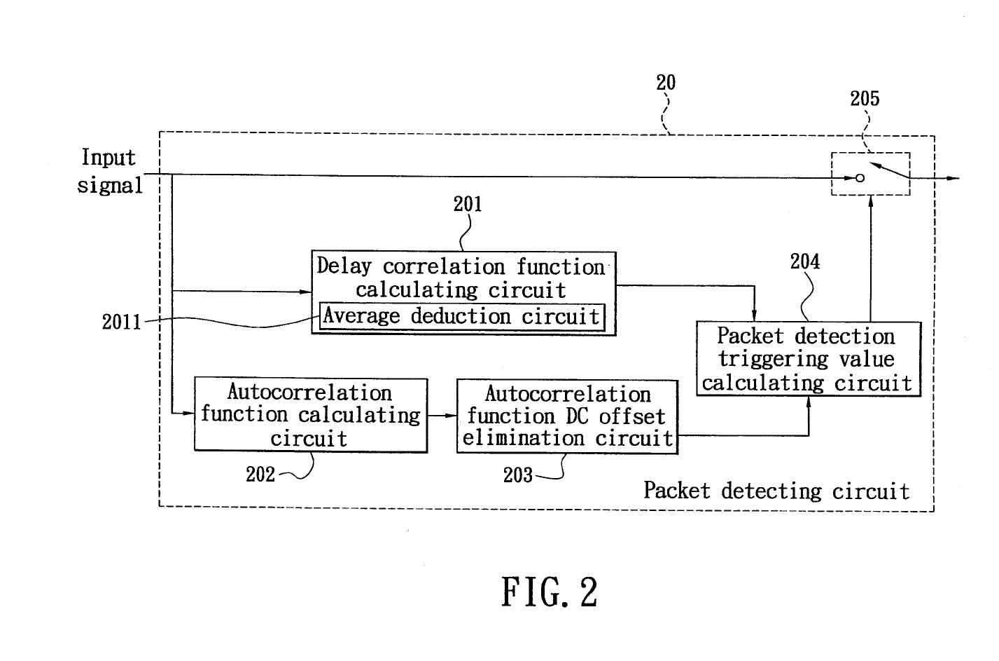

Referring to FIG. 2 showing a functional block diagram of a packet detecting circuit in accordance with a first preferred embodiment of the present invention, the packet testing circuit 20 comprises a delay correlation function calculating circuit 201, an autocorrelation function calculating circuit 202, an autocorrelation function DC offset elimination circuit 203, a packet detection triggering value calculating circuit 204, and a switching unit 205, wherein the delay correlation function calculating circuit 201 includes an average deduction circuit 2011.

The delay correlation function calculating circuit 201 is used for receiving an input signal, and calculating a delay correlation function for the input signal, and using an average deduction circuit 2011 to deduct an average of the signal, and eliminate the affection of the DC offset to obtain a more accurate delay correlation function.

From Formula 3, the computed delay correlation function of the signal has an extra

$${\sum }_{n = 0}^{N - 1} {\vert {P}_{0} \vert}^{2}$$

due to the DC offset, and thus causes misjudgment easily. Therefore, the delay correlation function of a signal provided by the delay correlation function calculating circuit 201 is calculated by:

$${\sum }_{n = 0}^{N - 1} ( {R}_{n} - \frac{{\sum }_{i = 0}^{N - 1} {R}_{n + i}}{N} ) \times {( {R}_{n + D} - \frac{{\sum }_{i = 0}^{N - 1} {R}_{n + D + i}}{N} )}^{*} \qquad ( Formula 7 )$$

where, Rₙ₊ᵢ=Sₙ₊ᵢ+Pₙ₊ᵢ, R_{n+D+i}=S_{n+D+i}+P_{n+D+i}, Pₙ₊ᵢ and P_{n+D+i} are DC offset values, Sₙ₊ᵢ is the value of an input signal, S_{n+D+i} is the value of an input signal after delaying D+i sampling points. Within a time period, the DC offset is a constant P₀, and Formula 7 becomes:

$${\sum }_{n = 0}^{N - 1} ( ( {S}_{n} + {P}_{0} ) - \frac{{\sum }_{i = 0}^{N - 1} ( {S}_{n + i} + {P}_{0} )}{N} ) \times {( ( {S}_{n + D} + {P}_{0} ) - \frac{{\sum }_{i = 0}^{N - 1} ( {S}_{n + D + i} + {P}_{0} )}{N} )}^{*} \qquad ( Formula 8 )$$

If the average of the signal is zero, Formula 8 is equivalent to:

$${\sum }_{n = 0}^{N - 1} ( ( {S}_{n} + {P}_{0} ) - \frac{{\sum }_{i = 0}^{N - 1} {P}_{0}}{N} ) \times {( ( {S}_{n + D} + {P}_{0} ) - \frac{{\sum }_{i = 0}^{N - 1} {P}_{0}}{N} )}^{*} = {\sum }_{i = 0}^{N - 1} {S}_{n} \times {S}_{n + D}^{*} \qquad ( Formula 9 )$$

From Formula 9, the result is equivalent to the situation without a DC offset (as shown in Formula 1), and thus the delay correlation function calculating circuit 201 calculates the delay correlation function to effectively eliminates the affection of the DC offset.

In FIG. 2, the autocorrelation function calculating circuit 202 receives an input signal and calculates the autocorrelation function for the signal, and the autocorrelation function DC offset elimination circuit 203 is used for calculating the DC offset value of a signal, and subtracting the DC offset value from the autocorrelation function by the autocorrelation function calculating circuit 202.

From Formula 6, an error of extra

$${\sum }_{n = 0}^{N - 1} {\vert {P}_{0} \vert}^{2}$$

occurs during the computation of the autocorrelation function for a signal due to the DC offset. The autocorrelation function DC offset elimination circuit 203 calculates an error caused by the DC offset, and eliminates the error from the autocorrelation function. The autocorrelation function calculating circuit 202 calculates the autocorrelation function by:

$${\sum }_{n = 0}^{N - 1} {\vert {R}_{n + D} \vert}^{2} \qquad ( Formula 10 )$$

where, R_{n+D}=S_{n+D}+P_{n+D}, S_{n+D} is the value of an input signal after delaying D sampling point, and P_{n+D} is a DC offset value. The autocorrelation function DC offset elimination circuit 203 calculates a DC offset value by:

$$\frac{{\vert {\sum }_{n = 0}^{N - 1} {R}_{n + D} \vert}^{2}}{N} \qquad ( Formula 11 )$$

In Formula 10, it is assumed that the DC offset within a time period is a constant P₀ and the average of a signal is zero, and thus

$$\frac{{\vert {\sum }_{n = 0}^{N - 1} {R}_{n + D} \vert}^{2}}{N} = \frac{{\vert {\sum }_{n = 0}^{N - 1} {S}_{n + D} + {P}_{0} \vert}^{2}}{N} = \frac{{\vert {\sum }_{n = 0}^{N - 1} {P}_{0} \vert}^{2}}{N} = {\sum }_{n = 0}^{N - 1} {\vert {P}_{0} \vert}^{2} \qquad ( Formula 12 )$$

The result of Formula 12 can eliminate the different terms of Formulas 4 and 6, such that after the autocorrelation function DC offset elimination circuit 203 calculates the DC offset, the DC offset value is deducted from the autocorrelation function as follows:

$${\sum }_{n = 0}^{N - 1} {\vert {R}_{n + D} \vert}^{2} - \frac{{\vert {\sum }_{n = 0}^{N - 1} {R}_{n + D} \vert}^{2}}{N} \qquad ( Formula 13 )$$

Therefore, a more accurate autocorrelation function can be obtained by the computational result of the autocorrelation function DC offset elimination circuit 203.

After the delay correlation function calculating circuit 201 and autocorrelation function DC offset elimination circuit 203 produce a delay correlation function and an autocorrelation function, the packet detection triggering value calculating circuit 204 calculates a packet detection triggering value according to the delay correlation function and autocorrelation function produced by the delay correlation function calculating circuit 201 and autocorrelation function DC offset elimination circuit 203 respectively”. Then a packet entry time can be obtained according to the packet detection triggering value for controlling the switching unit 205 to allow the packet to pass through.

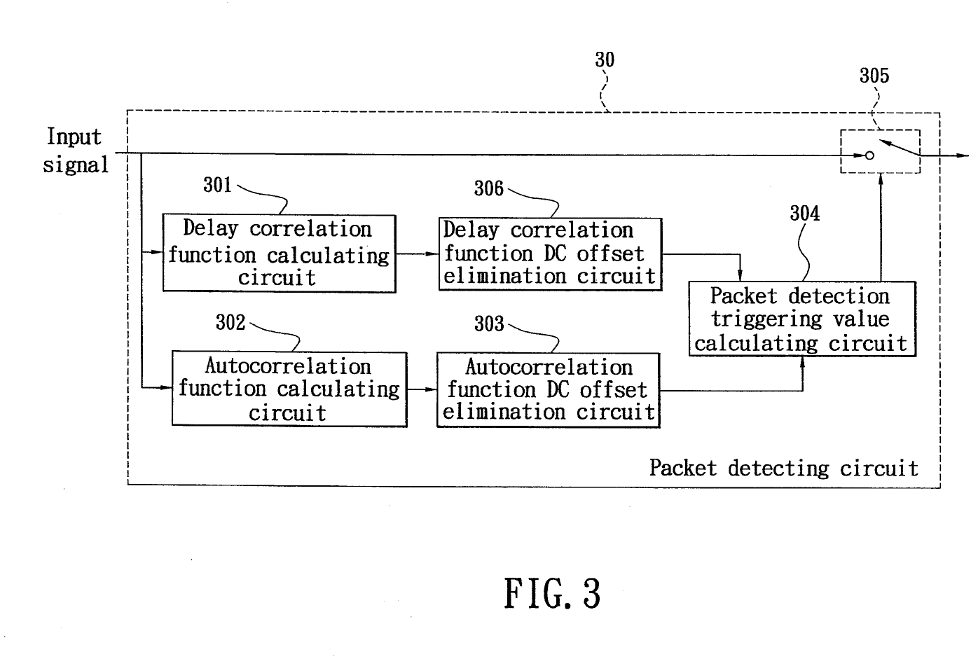

Referring to FIG. 3 showing a functional block diagram of a packet detecting circuit in accordance with a second preferred embodiment of the present invention, the packet testing circuit 30 comprises a delay correlation function calculating circuit 301, a delay correlation function DC offset elimination circuit 306, an autocorrelation function calculating circuit 302, an autocorrelation function DC offset elimination circuit 303, a packet detection triggering value calculating circuit 304, and a switching unit 305.

From Formula 3, an error of extra

$${\sum }_{n = 0}^{N - 1} {\vert {P}_{0} \vert}^{2}$$

occurs in the computation of a signal delay related power value due to the DC offset, and easily produces misjudgments. Therefore, the present invention uses a delay correlation function calculating circuit 301 to receive a signal and calculate the delay correlation function of a signal, and then the delay correlation function DC offset elimination circuit 306 eliminates the affection of the DC offset to the signal delay related power value to obtain a more accurate signal delay related power value.

The delay correlation function calculating circuit 301 calculates the delay correlation function by:

$${\sum }_{n = 0}^{N - 1} {R}_{n} \times {R}_{n + D}^{*} \qquad ( Formula 14 )$$

where, Rₙ=Sₙ+Pₙ, R_{n+D}=S_{n+D}+P_{n+D}, Pₙ and P_{n+D} are DC offset values, Sₙ is the value of an input signal, and S_{n+D} is the value of an input signal after delaying D sampling points.

The delay correlation function DC offset elimination circuit 306 calculates a first DC offset value by:

$${\sum }_{n = 0}^{N - 1} \frac{{\sum }_{i = 0}^{N - 1} {R}_{n + i} \times {\sum }_{i = 0}^{N - 1} {R}_{n + D + i}^{*}}{{N}^{2}} \qquad ( Formula 15 )$$

where, Rₙ₊ᵢ=Sₙ₊ᵢ+Pₙ₊ᵢ, R_{n+D+i}=S_{n+D+i}+P_{n+D+i}, Pₙ₊ᵢ and P_{n+D+i} are DC offset values, Sₙ₊ᵢ is the value of an input signal after delaying i sampling points, S_{n+D+i} is the value of an input signal after delaying D+i sampling points. Assumed that the DC offset value within a time period is a constant P₀ and an average of a signal is zero, the first DC offset value is:

$$\begin{matrix}{\sum }_{n = 0}^{N - 1} \frac{\begin{matrix}( {\sum }_{i = 0}^{N - 1} {S}_{n + i} + {P}_{0} ) \times \\ {( {\sum }_{i = 0}^{N - 1} {S}_{n + D + i} + {P}_{0} )}^{*}\end{matrix}}{{N}^{2}} = {\sum }_{n = 0}^{N - 1} \frac{( {\sum }_{i = 0}^{N - 1} {P}_{0} ) \times {( {\sum }_{i = 0}^{N - 1} {P}_{0} )}^{*}}{{N}^{2}} \\ = {\sum }_{n = 0}^{N - 1} {\vert {P}_{0} \vert}^{2}\end{matrix} \qquad ( Formula 16 )$$

The result of Formula 16 is used for eliminating the different terms in Formulas 1 and 3, such that after the delay correlation function DC offset elimination circuit 306 calculates a first DC offset value, the first DC offset value of the delay correlation function obtained by the delay correlation function calculating circuit 301 is eliminated as follows:

$${\sum }_{n = 0}^{N - 1} {R}_{n} \times {R}_{n + D}^{*} - {\sum }_{n = 0}^{N - 1} \frac{{\sum }_{i = 0}^{N - 1} {R}_{n + i} \times {\sum }_{i = 0}^{N - 1} {R}_{n + D + i}^{*}}{{N}^{2}} \qquad ( Formula 17 )$$

From Formulas 14, 15 and 16, the delay correlation function is obtained by the delay correlation function calculating circuit 301, and then the delay correlation function DC offset elimination circuit 306 calculates the first DC offset value, and the first DC offset value is deducted from the delay correlation function, so as to eliminate the affection of DC offset to the delay correlation function.

From Formula 6, an error of extra

$${\sum }_{n = 0}^{N - 1} {\vert {P}_{0} \vert}^{2}$$

occurs in the computation of the autocorrelation function for a signal due to the DC offset. The present invention uses an autocorrelation function DC offset elimination circuit 303 to calculate an error caused by a second DC offset, and then the error is deducted from the autocorrelation function calculated by the autocorrelation function calculating circuit 302. The autocorrelation function calculating circuit 302 receives a signal, and calculates a signal autocorrelation function by:

$${\sum }_{n = 0}^{N - 1} {\vert {R}_{n + D} \vert}^{2} \qquad ( Formula 18 )$$

where, R_{n+D}=S_{n+D}+P_{n+D}, S_{n+D} is the value of an input signal after delaying D sampling points, and P_{n+D} is a DC offset value. The autocorrelation function DC offset elimination circuit 303 calculates a second DC offset value by:

$$\frac{{\vert {\sum }_{n = 0}^{N - 1} {R}_{n + D} \vert}^{2}}{N} \qquad ( Formula 19 )$$

In Formula 19, assumed that the DC offset within a time period is a constant P₀ and an average of a signal is zero, Formula 20 is derived below:

$$\frac{{\vert {\sum }_{n = 0}^{N - 1} {R}_{n + D} \vert}^{2}}{N} = \frac{{\vert {\sum }_{n = 0}^{N - 1} {S}_{n + D} + {P}_{0} \vert}^{2}}{N} = \frac{{\vert {\sum }_{n = 0}^{N - 1} {P}_{0} \vert}^{2}}{N} = {\sum }_{n = 0}^{N - 1} {\vert {P}_{0} \vert}^{2} \qquad ( Formula 20 )$$

The result of Formula 20 is used for eliminating the different terms of Formulas 4 and 6, such that after the autocorrelation function DC offset elimination circuit 203 calculates the DC offset value, the DC offset value is eliminated from the autocorrelation function as follows:

$${\sum }_{n = 0}^{N - 1} {\vert {R}_{n + D} \vert}^{2} - \frac{{\vert {\sum }_{n = 0}^{N - 1} {R}_{n + D} \vert}^{2}}{N} \qquad ( Formula 21 )$$

The computational result of the autocorrelation function DC offset elimination circuit 303 can give a more accurate autocorrelation function.

After the delay correlation function DC offset elimination circuit 306 and autocorrelation function DC offset elimination circuit 303 produces a delay correlation function and an autocorrelation function, the packet detection triggering value calculating circuit 304 calculates a packet detection triggering value according to the delay correlation function and autocorrelation function produced by the delay correlation function DC offset elimination circuit 306 and the autocorrelation function DC offset elimination circuit 303 respectively. After that, a packet entry time is calculated according to the packet detection triggering value, so as to control the switching unit 305 to pass a packet.

In summation of the description above, the packet detecting circuit of the invention is not affected by the DC offset and can calculate accurate delay correlation function and autocorrelation function without including a DC offset, so that the packet can be detected more accurately. The variation of DC offset caused by other circuits or temperature will not affect the computation of delay correlation function and autocorrelation function by the packet detecting circuit.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A packet detecting circuit, comprising:
a delay correlation function calculating circuit, for receiving an input signal and calculating a delay correlation function for the input signal, and the delay correlation function calculating circuit includes an average deduction circuit, for deducting an average time period of the input signal;
an autocorrelation function calculating circuit, for receiving the input signal, and calculating an autocorrelation function for the input signal;
an autocorrelation function DC offset elimination circuit, for calculating a DC offset value, and subtracting the DC offset value from the autocorrelation function for the input signal; and
a packet detection triggering calculating circuit, for calculating a packet detection triggering value according to the output values of the delay correlation function calculating circuit and the autocorrelation function DC offset elimination circuit.

2. The packet detecting circuit as recited in claim 1, wherein the delay correlation function for the input signal is:
$${\sum }_{n = 0}^{N - 1} ( {R}_{n} - \frac{{\sum }_{i = 0}^{N - 1} {R}_{n + i}}{N} ) \times {( {R}_{n + D} - \frac{{\sum }_{i = 0}^{N - 1} {R}_{n + D + i}}{N} )}^{*} ,$$
wherein Rₙ₊ᵢ=Sₙ₊ᵢ+Pₙ₊ᵢ, R_{n+D+i}=S_{n+D+i}+P_{n+D+i}, and Pₙ₊ᵢ and P_{n+D+i} are DC offset values, Sₙ₊ᵢ is the value of an input signal, S_{n+D+i} is the value of an input signal after delaying D+i sampling points.

3. The packet detecting circuit as recited in claim 1, wherein a DC offset value of the autocorrelation function is:
$$\frac{{\vert {\sum }_{n = 0}^{N - 1} {R}_{n + D} \vert}^{2}}{N} ,$$
wherein R_{n+D}=S_{n+D}+P_{n+D}, and S_{n+D} is the value of an input signal after delaying D sampling points, and P_{n+D} is the DC offset value.

4. The packet detecting circuit as recited in claim 1, wherein the autocorrelation function DC offset elimination circuit has an output value of:
$${\sum }_{n = 0}^{N - 1} {\vert {R}_{n + D} \vert}^{2} - \frac{{\vert {\sum }_{n = 0}^{N - 1} {R}_{n + D} \vert}^{2}}{N} ,$$
wherein R_{n+D}=S_{n+D}+P_{n+D}, and S_{n+D} is the value of an input signal after delaying D sampling points, and P_{n+D} is the DC offset value.

5. A packet detecting circuit, comprising:
a delay correlation function calculating circuit, for calculating a delay correlation function for an input signal;
a delay correlation function DC offset elimination circuit, for calculating a first DC offset value, and subtracting the first DC offset value from a calculated result of the delay correlation function calculating circuit;
an autocorrelation function calculating circuit, for calculating the autocorrelation function for an input signal;
an autocorrelation function DC offset elimination circuit, for calculating a second DC offset value, and subtracting the second DC offset value from a calculated result of the autocorrelation function calculating circuit; and
a packet detection triggering calculating circuit, for calculating a packet detection triggering value according to the output values of the delay correlation function DC offset elimination circuit and the autocorrelation function DC offset elimination circuit.

6. The packet detecting circuit as recited in claim 5, wherein the first DC offset value is:
$${\sum }_{n = 0}^{N - 1} \frac{{\sum }_{i = 0}^{N - 1} {R}_{n + i} \times {\sum }_{i = 0}^{N - 1} {R}_{n + D + i}^{*}}{{N}^{2}} ,$$
wherein Rₙ₊ᵢ=Sₙ₊ᵢ+Pₙ₊ᵢ, R_{n+D+i}=S_{n+D+i}+P_{n+D+i}, and Pₙ₊ᵢ and P_{n+D+i} are the DC offset values, Sₙ₊ᵢ is the value of an input signal after delaying i sampling points, and S_{n+D+i} is the value of an input signal after delaying D+i sampling points.

7. The packet detecting circuit as recited in claim 5, wherein the delay correlation function DC offset elimination circuit has an output value of:
$${\sum }_{n = 0}^{N - 1} {R}_{n} \times {R}_{n + D}^{*} - {\sum }_{n = 0}^{N - 1} \frac{{\sum }_{i = 0}^{N - 1} {R}_{n + i} \times {\sum }_{i = 0}^{N - 1} {R}_{n + D + i}^{*}}{{N}^{2}} ,$$
wherein Rₙ=Sₙ+Pₙ, R_{n+D}=S_{n+D}+P_{n+D}, and Pₙ and P_{n+D} are the DC offset values, Sₙ is the value of an input signal, and S_{n+D} is the value of an input signal after delaying D sampling points.

8. The packet detecting circuit as recited in claim 5, wherein the second DC offset value is:
$$\frac{{\vert {\sum }_{n = 0}^{N - 1} {R}_{n + D} \vert}^{2}}{N} ,$$
wherein R_{n+D}=S_{n+D}+P_{n+D}, S_{n+D} is the value of an input signal after delaying D sampling points, and P_{n+D} is the DC offset value.

9. The packet detecting circuit as recited in claim 5, wherein the autocorrelation function DC offset elimination circuit has an output value of:
$${\sum }_{n = 0}^{N - 1} {\vert {R}_{n + D} \vert}^{2} - \frac{{\vert {\sum }_{n = 0}^{N - 1} {R}_{n + D} \vert}^{2}}{N} ,$$
wherein R_{n+D}=S_{n+D}+P_{n+D}, S_{n+D} is the value of an input signal after delaying D sampling points, and P_{n+D} is the DC offset value.

10. A packet detecting method, comprising the steps of:
receiving a signal;
calculating a delay correlation function for the signal, wherein the delay correlation function is generated by deducting an average time period of the signal;
calculating an autocorrelation function;
calculating a DC offset value;
subtracting the DC offset value from the autocorrelation function; and
calculating a packet detection triggering value according to the delay correlation function and the autocorrelation function after subtracting the DC offset value.

11. The packet detecting method as recited in claim 10, wherein the delay correlation function for the signal is calculated by:
$${\sum }_{n = 0}^{N - 1} ( {R}_{n} - \frac{{\sum }_{i = 0}^{N - 1} {R}_{n + i}}{N} ) \times {( {R}_{n + D} - \frac{{\sum }_{i = 0}^{N - 1} {R}_{n + D + i}}{N} )}^{*} ,$$
wherein Rₙ=Sₙ+Pₙ, R_{n+D}=S_{n+D}+P_{n+D}, Pₙ and P_{n+D} are DC offset values, Sₙ is the value of the signal, and S_{n+D} is the value of the signal after delaying D sampling points.

12. The packet detecting method as recited in claim 10, wherein the DC offset value is calculated by:
$$\frac{{\vert {\sum }_{n = 0}^{N - 1} {R}_{n + D} \vert}^{2}}{N} ,$$
wherein R_{n+D}=S_{n+D}+P_{n+D}, S_{n+D} is the value of a signal after delaying D sampling points, and P_{n+D} is a DC offset value.

13. The packet detecting method as recited in claim 10, wherein the autocorrelation function subtracting the DC offset value is calculated by:
$${\sum }_{n = 0}^{N - 1} {\vert {R}_{n + D} \vert}^{2} - \frac{{\vert {\sum }_{n = 0}^{N - 1} {R}_{n + D} \vert}^{2}}{N} ,$$
wherein R_{n+D}=S_{n+D}+P_{n+D}, S_{n+D} is the value of a signal after delaying D sampling points, and P_{n+D} is a DC offset value.

14. A packet detecting method, comprising the steps of:
receiving a signal;
calculating a delay correlation function;
calculating a first DC offset value;
subtracting the first DC offset value from the delay correlation function;
calculating an autocorrelation function;
calculating a second DC offset value;
subtracting the second DC offset value from the autocorrelation function; and
calculating a packet detection triggering value according to the delay correlation function subtracting the first DC offset value and the autocorrelation function subtracting the second DC offset value.

15. The packet detecting method as recited in claim 14, wherein the first DC offset value is calculated by:
$${\sum }_{n = 0}^{N - 1} \frac{{\sum }_{i = 0}^{N - 1} {R}_{n + i} \times {\sum }_{i = 0}^{N - 1} {R}_{n + D + i}^{*}}{{N}^{2}} ,$$
wherein Rₙ₊ᵢ=Sₙ₊ᵢ+Pₙ₊ᵢ, R_{n+D+i}=S_{n+D+i}+P_{n+D+i}, Pₙ₊ᵢ and P_{n+D+i} are the DC offset values, Sₙ₊ᵢ is the value of the signal after delaying i sampling points, S_{n+D+i} is the value of the signal after delaying D+i sampling points.

16. The packet detecting method as recited in claim 14, wherein the delay correlation function subtracts the first DC offset value by
$${\sum }_{n = 0}^{N - 1} {R}_{n} \times {R}_{n + D}^{*} - {\sum }_{n = 0}^{N - 1} \frac{{\sum }_{i = 0}^{N - 1} {R}_{n + i} \times {\sum }_{i = 0}^{N - 1} {R}_{n + D + i}^{*}}{{N}^{2}} ,$$
wherein Rₙ=Sₙ+Pₙ, R_{n+D}=S_{n+D}+P_{n+D}, Pₙ and P_{n+D} are the DC offset values, Sₙ is the value of a signal, and S_{n+D} is the value of the signal after delaying D sampling points.

17. The packet detecting method as recited in claim 14, wherein the second DC offset value is calculated by:
$$\frac{{\vert {\sum }_{n = 0}^{N - 1} {R}_{n + D} \vert}^{2}}{N} ,$$
wherein R_{n+D}=S_{n+D}+P_{n+D}, S_{n+D} is the value of the signal after delaying D sampling points, and P_{n+D} is the DC offset value.

18. The packet detecting method as recited in claim 14, wherein the autocorrelation function subtracts the second DC offset value by:
$${\sum }_{n = 0}^{N - 1} {\vert {R}_{n + D} \vert}^{2} - \frac{{\vert {\sum }_{n = 0}^{N - 1} {R}_{n + D} \vert}^{2}}{N} ,$$
wherein R_{n+D}=S_{n+D}+P_{n+D}, S_{n+D} is the value of the signal after delaying D sampling points, and P_{n+D} is the DC offset value.
